(19) United States
(12) Patent Application Publication
(10) Pub. No.: US 2012/0236904 A1
(43) Pub. Date: Sep. 20, 2012

(54) DIRECT THERMOCOUPLE MEASUREMENT WITHOUT A REFERENCE JUNCTION

(76) Inventor: Brian Mark Burmaster, Beirut (LB)

(21) Appl. No.: 13/407,649

(22) Filed: Feb. 28, 2012

Related U.S. Application Data
(60) Provisional application No. 61/465,102, filed on Mar. 14, 2011.
(60) Provisional application No. 61/631,556, filed on Jan. 6, 2012.

(51) Int. Cl. G01K 7/02

(52) U.S. Cl. 374/179; 374/E07.004

(57) ABSTRACT

Electronic measurement of thermocouples has employed cold junction reference since Thomas Seebeck's discovery in 1820's. This patent discloses that thermocouple compensation is not needed nor wanted. Non-compensated thermocouple data which supports this claim is given in this patent.

### PRIORITY CLAIM

The present application claims the benefit of copending U.S. Provisional Patent Application No. 61/465,102, filed Mar. 14, 2011; the present application also claims the benefit of copending U.S. Provisional Patent Application No. 61/631,556, filed Jan. 6, 2012; all of the foregoing applications are incorporated herein by reference in their entireties.

### TECHNICAL FIELD

This invention relates generally to thermocouples and more particularly to measurement of temperature using a thermocouple without using a reference junction.

### BACKGROUND

Thomas Seebeck's original experiment was reported in The Journal Abt. D. Konigl, Alak. D Wiss Berlin 1822-1823, p 265, in the article “Evidence of the thermal current of the combination Bi—Cu by its action on magnetic needle”. Figure One shows a drawing of the well-known Seebeck effect, where there exists two wires of dissimilar metal conductors (A+) and (B−) with two electrical junctions, one being hot (T_{H}) and the other being cold (T_{C}). From Seebeck's reasoning, a current will only flow in the circuit as long as the two junctions are at different temperatures and that the voltage difference (V_{S}) can only be measured with both junctions employed.

Following Seebeck's insistence on employing a reference junction, the current state of accurate electronic temperature measurements is not simple. There exists a large selection of temperature sensors; each one with its own limitations. Generally, the most prevalent sensing devices are thermocouples, thermistors and resistance temperature detectors. Diodes and transistors have been used previously, but they are not sold for widespread temperature sensing because of their inherent limitations. Thermistors are highly non-linear making wide range measurements difficult. Resistance temperature detections are large, requiring an electronic bridge and are relatively costly. Thermocouples are small, inexpensive and relatively linear, but according to Seebeck's teaching require a reference junction in order to provide an electrical signal.

Seebeck's linear relationship with A_{S} being Seebeck's coefficient and is given by:

V_{S}=A_{S}*(T_{H}−T_{C})

The actual value of Seebeck's coefficient is dependent on the type of thermocouple that is used and Table One below shows those values:

TABLE ONE
Seebeck Coefficient

| Thermocouple | Seebeck | Positive | Negative |
|---|---|---|---|
| Type | Coefficient | Metal | Metal |
| E | 61 μV/° C. | Chrome Alloy | Constantan Alloy |
| J | 52 μV/° C. | Iron | Constantan Alloy |
| K | 41 μV/° C. | Chrome Alloy | Aluminum Alloy |
| N | 27 μV/° C. | Nicrosil Alloy | Nisil Alloy |
| R | 9 μV/° C. | Platinum Alloy | Rhodium Alloy |
| S | 6 μV/° C. | Platinum Alloy | Rhodium Alloy |
| T | 41 μV/° C. | Copper | Constantan Alloy |

In future work, it was found that Seebeck's constant was actually a polynomial expansion function (for example: A_{S}=a₀+a₁*T¹+a₂*T²+a₃*T³ . . . ) which depended on the measuring temperature, and that being usually the hot side temperature. Likewise, the cold side junction reference was set in an ice bath at 0° C., and at that temperature, the voltage reading was referenced as 0.0 millivolt, independent of any thermocouple metals used. Thus, all National Institute of Standards and Technology tables report that 0° C. is 0.000 millivolt. For example, the J-thermocouple table data can be found on the Internet at the following address: http://srdata.nistgov/its90/download/type_j.tab

Other thermocouple data can similarly be found at that website, and both the J and K thermocouple data are given later in this patent. All thermocouple data on this US Government website is referenced with an ice bath temperature (0° C.).

For current understanding and thinking of electronic thermocouple measurements, a reference literature article entitled “Two Ways to Measure Temperature Using Thermocouples Feature Simplicity, Accuracy and Flexibility” is helpful by Analog Device engineers Matthew Duff and Joseph Towey, which was published in the Journal Analog Dialogue (Volume 44-10 October 2010). In this article, the reference junction as established by Seebeck in 1821 is employed in various different methods to ascertain the measured temperature against the differential voltage of the measured and reference junction. Along with other semiconductor firms, Analog Devices manufactures integrated circuits employing silicon chip technology that converts the thermocouple wire input into a voltage output signal, which is ultimately converted from this referenced analog output to digital information.

As a working example, Analog Devices (a publicly traded semiconductor manufacturer headquartered in Norwood, Mass.) manufactures an integrated circuit silicon chip (AD-594) which will be used to demonstrate the current technology in thermocouple temperature electronic measurement. This complex transistor device employs Seebeck's original insistence that a reference junction must be employed. The chip's name is aptly called “Monolithic Thermocouple Amplifiers with Cold Junction Compensation”. There are fourteen electrical connections per the drawing shown in Figure Two. Many of those connectors or pins are dedicated to providing the cold junction reference temperature and voltage, which current technology deems as absolute necessary in order to provide an output voltage signal.

Table Two shows the detailed list of those electrical connections, where according to standard semiconductor technology numbering system, the first pin (#1) is assigned to the lower left position and numbering proceeds in a counter-clockwise manner to the last pin (#14 in this case) which is located on the upper right corner.

TABLE TWO
Analog Device AD-594

| Electrical | Pin | Electrical Pin |
|---|---|---|
| Pin Number | Designation | Description |
| 1 | +IN | Input Thermocouple Wire (+) |
| 2 | +C | Input Compensation Wire (+) |
| 3 | +T | +Adjustment to Ice Point |
| 4 | COM | Common Ground (0 VDC) |
| 5 | −T | −Adjustment to Ice Point |
| 6 | −C | Input Compensation Wire (−) |
| 7 | V− | Common Ground (0 VDC) |
| 8 | FB | Output Voltage (0° C. = 0 mv) |
| 9 | VO | Output Voltage (10 mv/° C.) |
| 10 | COMP | Feedback Gain Modification |
| 11 | V+ | Supply Voltage (+5 VDC) |
| 12 | +ALM | High Alarm Output (+) |
| 13 | −ALM | Common Ground (0 VDC) |
| 14 | −IN | Input Thermocouple Wire (−) |

As seen by this table, many of the electrical connections are associated with providing a signal for the ice bath temperature compensation. Similarly, the electrical schematic for Analog Device's AD-594 is very complex as seen in Figure Three and much of the circuit is devoted to referencing the output voltage signal to the ice bath point, so that 0° C. is 0.000 millivolt in accordance with the National Institute of Standards and Technology tables, which are consistent with the teachings of Seebeck.

Analog Device is not the only semiconductor company to use a cold junction reference for thermocouple wiring. Many American integrated circuit firms offer similar technology, as seen below in Table Three:

TABLE THREE
American Semiconductor Firms with Cold Junction Reference

| Semiconductor | Integrated | Corporate |
|---|---|---|
| Company | Chip Number | Headquarters |
| Analog Device | AD-594 | Norwood, MA |
| Linear Technology | LT-1025 | Milpitas, CA |
| Maxim Technology | 6675 | Sunnyvale, CA |
| Microchip Technology | AN-929 | Chandler, AZ |
| National Semiconductor | AN-225 | Santa Clara, CA |

This list is not exhaustive, but it is clear that the semiconductor industry utilizes the cold junction reference for all thermocouple connections, meaning that 0° C. is 0.0 millivolt. There are no industrial practices or even scientific literature on non-compensated thermocouple voltages or connections.

A review of the prior art patents confirm that cold junction referencing must be practiced with thermocouple devices. A recently issued patent (U.S. Pat. No. 7,994,416 by W. Shuh on Aug. 9, 2011) and assigned to Watlow Electric Manufacturing entitled “Semi-compensated Pins for Cold Junction Compensation” is of particular interest. As reported in that patent, K-thermocouple voltage is given as 4.096 millivolt at 100° C. in Figure Four. However, this value has been referenced so that 0° C. is 0.0 millivolt, meaning that the actual voltage produced by a K-thermocouple is not known. This patent shows various “errors” in measurement which actually is the deviation from the “K” thermocouple table. All thermocouple readings used a standard cold junction reference at 0° C., meaning that Shuh has followed Seebeck's original teaching. The errors in these reported values range from 0° C. to 10° C., which is extremely high or 10% of full scale, since the standard errors are usually in the range of <1%.

All the prior art (some 31 patents) that is referenced in the Shuh patent, using thermocouple connections employ a reference junction, which is typically at the cold end and the hot end is devoted to the measuring thermocouple junction. There are no reported voltages for non-compensated temperatures anywhere in either patents or the scientific literature. This fact underscores the fundamental problem with compensation using reference junctions and forcing all thermocouple voltages to be 0.0 my at 0° C.

From real measurements made in the laboratory, as described in later sections, the actual 0.0 millivolt output level is extremely close to room temperature for both J and K thermocouples. Specifically,

J thermocouple temperature=21.8° C. for 0.0 millivolt output

K thermocouple temperature=20.5° C. for 0.0 millivolt output

Any attempt to compensate the thermocouple data to another reference temperature, such as 0° C. per the standard thermocouple tables will invariably lead to higher measurement errors and an overly complex system. This invention is therefore truly novel and non-obvious.

### SUMMARY

In accordance with this invention, thermocouple measurements can be made without a reference junction, either hot or cold. Following this new principle will result in a simplified semiconductor design and much improved accuracy and repeatability of measurements. It is, therefore, the principal object of this invention to provide means for achieving this result by direct amplification, without compensation.

Still another object of this invention is to provide improved accuracy in thermocouple measurements by observing that non-compensated “J” and “K” thermocouple devices output 0.0 millivolt at room temperature.

Another object of this invention is to reduce the cost associated with temperature measurements using thermocouples by simplifying the design.

These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings:

FIG. 1 provides a schematic of the original Seebeck's thermocouple measurements using a hot and cold junction;

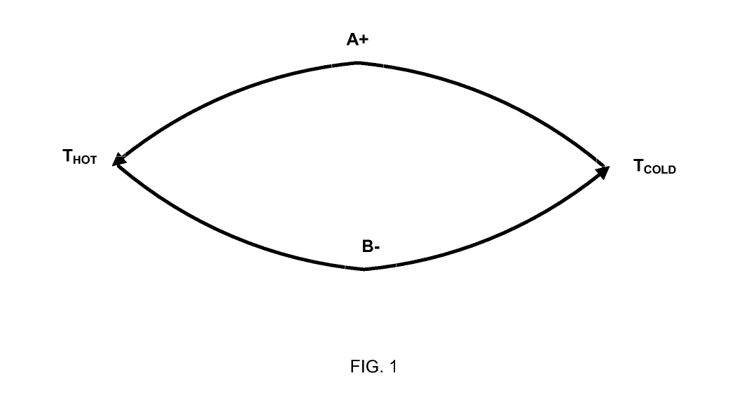

FIG. 2 displays electrical pin numbers of Analog Devices AD-594;

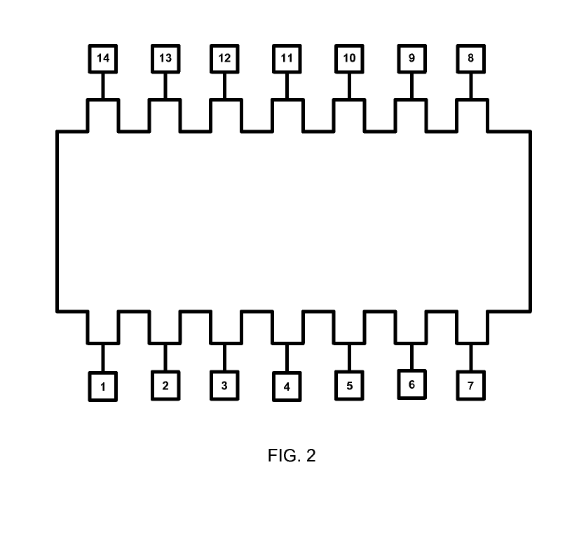

FIG. 3 shows the electrical schematic associated with Analog Devices AD-594;

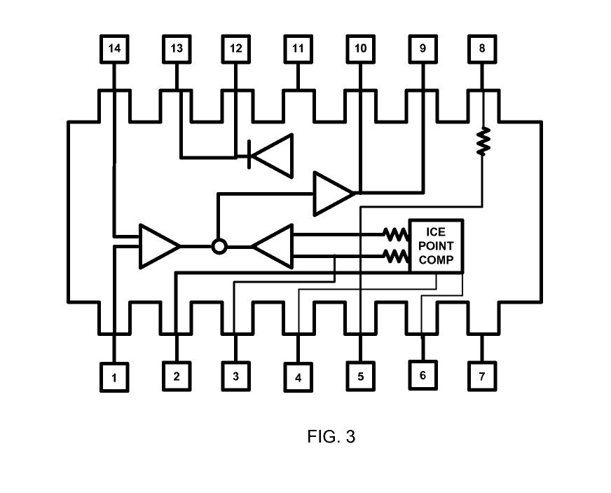

FIG. 4 discloses the operational amplifier used to measure the output voltage;

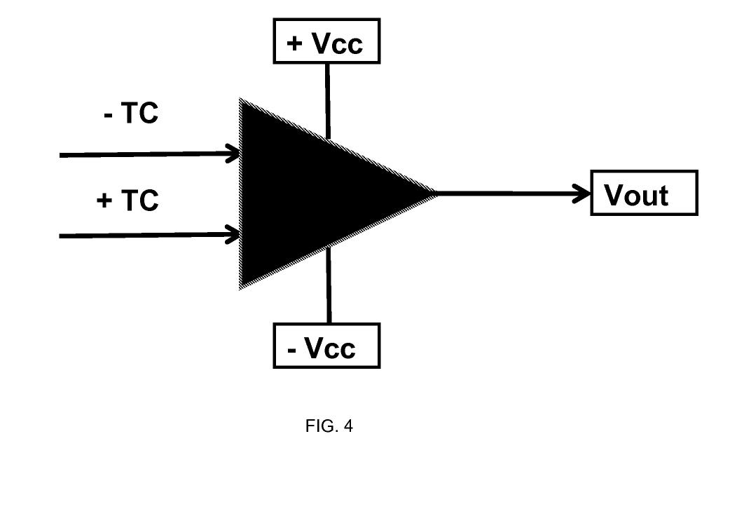

FIG. 5 illustrates the laboratory experimental station;

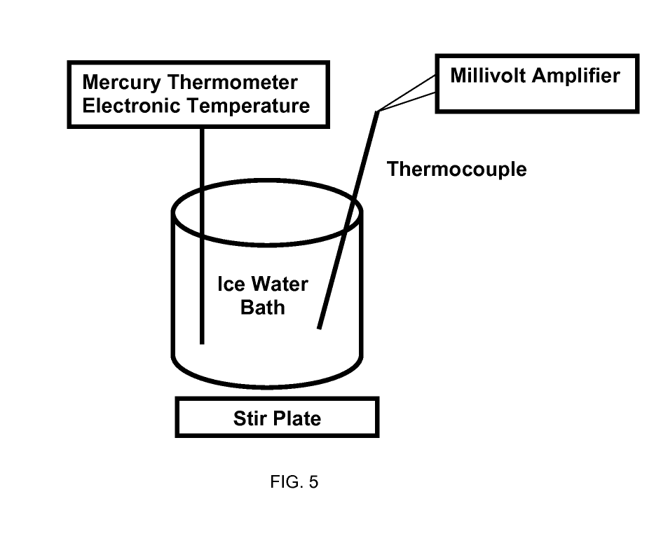

FIG. 6 is a Cartesian graph of the non-compensated “J” thermocouple data; and

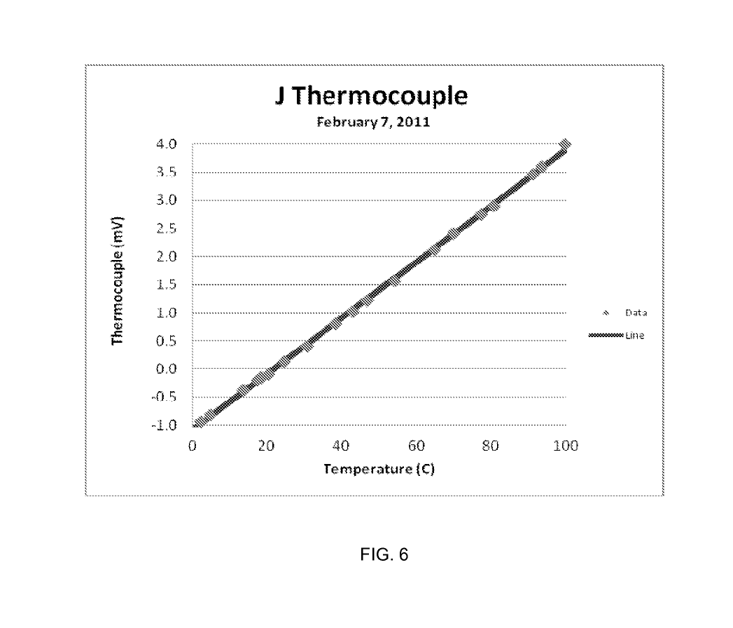

FIG. 7 is a Cartesian graph of the non-compensated “K” thermocouple data.

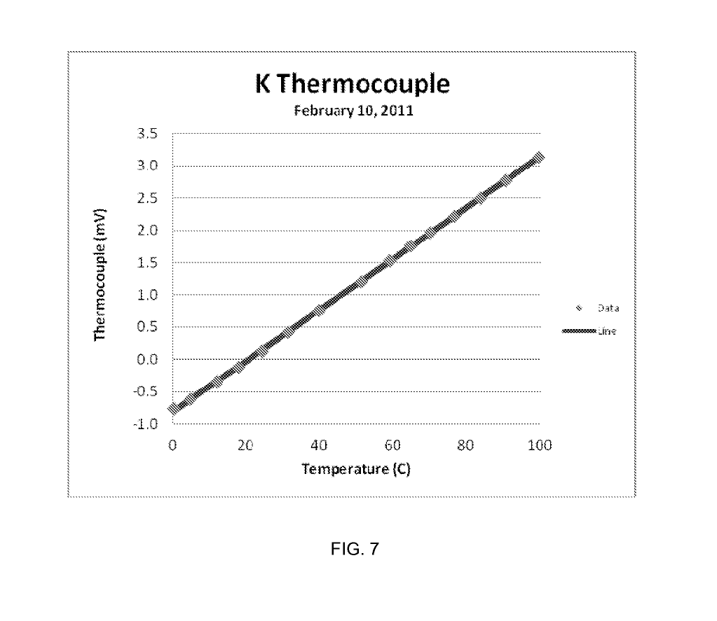

### DETAILED DESCRIPTION

Electrical measurements of thermocouples have been compensated with another bimetallic reference junction since Seebeck's discovery of 1821, as seen in Figure One. Ultimately, this invention destroys that long-held practice, which continues to this day in the semiconductor industry, as seen by Analog Device's integrated circuit in Figure Two and Three. Compensation leads to higher error and a more complex design.

With the current state of art, which employs either cold or hot junction references, the reported errors in temperature measurement (as given by the Watlow thermocouple catalog page 20) with standard thermocouples is poor, as shown in Table Four:

TABLE FOUR
Standard Errors for Current Thermocouples

| Thermocouple | Temperature Range | Standard |
|---|---|---|
| Letter | (° F.) | Error |
| B | 1600 to 3100 | +/−0.500% |
| E | 32 to 600 | +/−3° F. |
| | 600 to 1600 | +/−0.500% |
| J | 32 to 530 | +/−4° F. |
| | 530 to 1400 | +/−0.750% |
| K, N | 32 to 530 | +/−4° F. |
| | 530 to 2300 | +/−0.750% |
| R or S | 32 to 1000 | +/−2.5° F. |
| | 1000 to 2700 | +/−0.250% |
| T | −300 to −150 | |
| | −150 to −75 | +/−2% |
| | −75 to 200 | +/−1.5° F. |
| | 200 to 700 | +/−0.750% |

Absolute average errors using this invention by not compensating the thermocouple leads were significantly lower for both thermocouple data. The “J” thermocouple absolute average error was 0.05% while “K” averaged 0.02% of full scale (100° C.).

The primary reason that thermocouples continue to be compensated with a cold junction is that all temperature measurements are currently referenced to 32° F. or 0° C., with a reported value of 0.000 millivolt, in order to conform to the National Institute of Standards and Technology tables.

The “K” thermocouple readings are shown below in Table Five:

TABLE FIVE
“K” Thermocouple Table

| ° C. | 0 | 1 | 2 | 3 | 4 | 5 | 6 | 7 | 8 | 9 |
|---|---|---|---|---|---|---|---|---|---|---|
| 0 | 0.000 | 0.039 | 0.079 | 0.119 | 0.158 | 0.198 | 0.238 | 0.277 | 0.317 | 0.357 |
| 10 | 0.397 | 0.437 | 0.477 | 0.517 | 0.557 | 0.597 | 0.637 | 0.677 | 0.718 | 0.758 |
| 20 | 0.798 | 0.838 | 0.879 | 0.919 | 0.960 | 1.000 | 1.041 | 1.081 | 1.122 | 1.163 |
| 30 | 1.203 | 1.244 | 1.285 | 1.326 | 1.366 | 1.407 | 1.448 | 1.489 | 1.530 | 1.571 |
| 40 | 1.612 | 1.653 | 1.694 | 1.735 | 1.776 | 1.817 | 1.858 | 1.899 | 1.941 | 1.982 |
| 50 | 2.023 | 2.064 | 2.106 | 2.147 | 2.188 | 2.230 | 2.271 | 2.312 | 2.354 | 2.395 |
| 60 | 2.436 | 2.478 | 2.519 | 2.561 | 2.602 | 2.644 | 2.685 | 2.727 | 2.768 | 2.810 |
| 70 | 2.851 | 2.893 | 2.934 | 2.976 | 3.017 | 3.059 | 3.100 | 3.142 | 3.184 | 3.225 |
| 80 | 3.267 | 3.308 | 3.350 | 3.433 | 3.433 | 3.474 | 3.516 | 3.557 | 3.599 | 3.640 |
| 90 | 3.682 | 3.723 | 3.765 | 3.806 | 3.848 | 3.889 | 3.931 | 3.972 | 4.013 | 4.055 |

All non-Bold Values are in millivolts

In strict adherence to Seebeck's regimented thinking, this “K” thermocouple data is referenced such that 0 millivolt signal is 0° C., per the value shown in the top left quadrant of this table. A reference cold junction must be employed in order to zero these temperature values.

All thermocouple data, tabulated by the National Institute Standards and Technology (NIST) and found elsewhere is presented according to this very strict protocol. In order to hammer this point, the “J” thermocouple data which is published by the NIST and others have been standardized using a cold reference junction at the freezing temperature of water. The measuring bimetallic thermocouple junction is the hot side, with the positive and negative thermocouple wires kept separated.

The “J” thermocouple readings are shown below in Table Six:

TABLE SIX
“J” Thermocouple Table

| | 0 | 1 | 2 | 3 | 4 | 5 | 6 | 7 | 8 | 9 |
|---|---|---|---|---|---|---|---|---|---|---|
| 0 | 0.000 | 0.050 | 0.101 | 0.151 | 0.202 | 0.253 | 0.303 | 0.354 | 0.405 | 0.456 |
| 10 | 0.507 | 0.558 | 0.609 | 0.660 | 0.711 | 0.762 | 0.814 | 0.865 | 0.916 | 0.968 |
| 20 | 1.019 | 1.071 | 1.122 | 1.174 | 1.226 | 1.277 | 1.329 | 1.381 | 1.433 | 1.485 |
| 30 | 1.537 | 1.589 | 1.641 | 1.693 | 1.745 | 1.797 | 1.849 | 1.902 | 1.954 | 2.006 |
| 40 | 2.059 | 2.111 | 2.164 | 2.216 | 2.269 | 2.322 | 2.374 | 2.427 | 2.480 | 2.532 |
| 50 | 2.585 | 2.638 | 2.691 | 2.744 | 2.797 | 2.850 | 2.903 | 2.956 | 3.009 | 3.062 |
| 60 | 3.116 | 3.169 | 3.222 | 3.275 | 3.329 | 3.382 | 3.436 | 3.489 | 3.543 | 3.596 |
| 70 | 3.650 | 3.703 | 3.757 | 3.810 | 3.864 | 3.918 | 3.971 | 4.025 | 4.079 | 4.133 |
| 80 | 4.187 | 4.240 | 4.294 | 4.348 | 4.402 | 4.456 | 4.510 | 4.564 | 4.618 | 4.672 |
| 90 | 4.726 | 4.781 | 4.835 | 4.889 | 4.943 | 4.997 | 5.052 | 5.106 | 5.160 | 5.215 |

All non-Bold Values are in millivolts

Until this patent publication, there was no other thermocouple data and hence all temperature measurements had to be referenced in this highly regimented, costly and overly complex manner.

To usurp nearly two centuries of thermocouple measurements and standardized tables as reported by the National Institute of Standards and Technology is novel and not obvious to anyone skilled in the art.

The invention is the first time in temperature measurement history that a thermocouple was wired directly to a highly accurate and precise millivolt amplifier and the results being tabulated without any reference compensation. Specifically, the Data-Forth (of Tucson, Az. 85706) Model SCM5B30-01 operational amplifier (SN# 59482-8) with the following calibration data was used:

TABLE SEVEN
Calibration Data for Dataforth Millivolt Amplifier (500X)

| Input | Calculated | Measured | Computed |
|---|---|---|---|
| Voltage (mv) | Output (V) | Output (V) | Error (%) |
| −10.009 | −5.005 | −4.999 | +0.051% |
| −4.997 | −2.499 | −2.495 | +0.034% |
| +0.002 | +0.001 | +0.003 | +0.019% |
| +5.005 | +2.503 | +2.504 | +0.011% |
| +9.990 | +4.995 | +4.995 | −0.003% |

This electronic amplifier was inside a laboratory where the ambient room temperature ranged during that week from 17.2° C. to 22.8° C. The thermocouple was placed in a temperature controlled water bath, where both electronic device and a mercury thermometer were used to accurately gauge the bath temperature which ranged from the freezing point of water (0° C.) to the boiling point of water (100° C.).

The “J” thermocouple data results are shown as a Cartesian coordinate graph in Figure Six and the “K” thermocouple data are displayed in a similar fashion in Figure Seven. Both graphs are highly linear, meaning that the non-compensated Seebeck coefficient within this tight temperature range appears to be a constant value and does not change significantly between 0° C. and 100° C.

The linear relationship for the data is given as:

J-Thermocouple: Voltage-TC (millivolt)=0.0499 * T (° C.)−1.0862

K-Thermocouple: Voltage-TC (millivolt)=0.0395 * T (° C.)−0.8107

The Seebeck non-compensated temperature coefficients are relatively close to the earlier reported National Institute of Standard and Technology values in Table Two. Likewise, the non-compensated thermocouple null voltage (Voltage=0.000 mv) can be computed from these linear relationships and are found to be close to room temperature, meaning that referencing to a lower temperature (0° C.) would introduce unnecessary error and complexity.

TABLE EIGHT
Seebeck Coefficient

| | NIST | Uncompensated | Uncompensated |
|---|---|---|---|
| Thermocouple | Seebeck | Seebeck | 0.0 mv |
| Type | Coefficient | Coefficient | Temperature |
| J | 52 μV/° C. | 49.9 μV/° C. | 21.8° C. |
| K | 41 μV/° C. | 39.5 μV/° C. | 20.5° C. |

In its most basic form, thermocouple voltages are directly measured without a secondary junction which is employed as a reference for electronic temperature readings and amplified directly or digitized without the complexity of another junction.

There is no data in the scientific literature or previous patents where non-compensated and direct thermocouple voltages were ever measured in recorded human history prior to this patent application.

In its simplest form, thermocouple wires are connected directly without another reference junction. These wires can be connected on a printed circuit board directly to a high precision and highly accurate operational amplifier with a gain of 500×, per this working example. The electrical leads for these boards are typically constructed of copper but since this junction is close to room temperature and its Seebeck coefficient is much lower, the error will be negligible. Additionally, this semiconductor device, an operational amplifier is near room temperature, the error in the measurement will be low. There is no need to provide a reference junction set at the ice point temperature, which is currently practiced, as seen by the Analog Devices AD-594 integrated circuit. Figure Four of this patent shows the preferred embodiment which in its simplest form has only five electrical connections versus AD-594 fourteen connections. The thermocouple connectors (+TC and −TC) could be constructed of the same metallic alloy compound if deemed necessary, such as copper.

The complexity of the current industrial practice (see Table 3 previously) of providing ice bath temperature compensation is totally unnecessary and not wanted. This additional signal processing which compares millivolt outputs from the measuring and reference junctions adds cost to all thermocouple electronic measurements and introduces significant error to the overall temperature measurement, as seen in Figure Three of the schematic. Finally, with the current semiconductor design, the output will be less linear, when reference junctions are strictly followed.

This invention is elegantly simple.

Obviously, this principle of not compensating or referencing all thermocouples can be extended with this disclosure and is in the realm of this patent disclosure. Data on less common thermocouples type, such as B,E,N,R,S and T could be taken without a reference junction in a similar manner as reported in this unique patent application.

These thermocouples could be directly wired into a non-compensated electronic amplifier as outlined in this application.

Other operational amplifiers with different gains (from 1 to 10,000) could be employed, beside the aforementioned Dataforth Model SCM5B30-01 integrated circuit board, as well and are in the scope of this patent application.

Since all published literature and patents prior to this patent application have always used a reference junction since Seebeck's original discovery of 1821, any electronic device that does not employ a cold or hot temperature compensating junction in thermocouple electrical measurement is an embodiment of this patent.

What is claimed:

1. Electrical thermocouple voltage measurements are made without employing a reference or compensation junction.

2. These non-compensated electrical thermocouple voltage measurements can be correlated directly to an accurately measured temperature.

3. Electrical leads from the thermocouple probe (both positive and negative) are wired directly into an electronic device, which outputs the temperature either in digital or analog manner in accordance with claim 1.

4. A measurement in accordance with claim 1 where that millivolt signal is magnified using an operational amplifier.

5. The operational amplifier in accordance with claim 3 is a highly accurate and precise electronic device with a gain of 1 to 1,000 times the input millivolt signal.

6. The highly accurate voltage signal from the operational amplifier in accordance with claims 3 and 4 can be digitized using conventional analog to digital conversion technology.

7. The electronic device of claim 1 is maintained close to room temperature, so that the connection voltage differential is 0.0 millivolt.
